(19) United States
(12) Patent Application Publication
(10) Pub. No.: US 2015/0182887 A1
(43) Pub. Date: Jul. 2, 2015

(54) METHOD AND APPARATUS FOR USING BACKWASH TO CLEAN A BAR RACK IN A WASTE WATER TREATMENT SYSTEM

(71) Applicant: ClearCove Systems, Inc., Rochester, NY (US)

(72) Inventor: Terry Wright, Rochester, NY (US)

(21) Appl. No.: 14/469,647

(22) Filed: Aug. 27, 2014

Related U.S. Application Data
(63) Continuation-in-part of application No. 14/142,099, filed on Dec. 27, 2013.

(51) Int. Cl. B01D 29/66; B01D 29/60; C02F 1/00

(52) U.S. Cl. CPC B01D 29/668; C02F 1/004; C02F 1/008; B01D 29/601; C02F 2101/32

(57) ABSTRACT

A system for backflushing materials from the upstream side of a bar screen in a primary waste water treatment installation having a reservoir of influent material disposed within a primary settling tank on the downstream side of the bar screen, wherein the system comprises a drain pipe in communication with the interior of the primary settling tank, a drain valve disposed in the drain pipe, and a programmable controller controllably connected to the drain valve and to an influent supply valve disposed in an influent supply pipe connected to an entry port in the primary settling tank. Preferably the system includes a first sensor disposed within the settling tank and a second sensor and flowmeter disposed within the drain pipe. Backflushing is provided by reverse flow of influent from the reservoir when the influent supply valve is closed and the drain valve is opened.

### RELATIONSHIP TO OTHER PATENTS AND APPLICATIONS

The present application is a Continuation-In-Part of a pending US Patent Application, Ser. No. 14/142,099, filed Dec. 27, 2013, which is incorporated herein by reference for all purposes.

### FIELD OF THE APPLICATION

The present invention relates to a floatables and scum removal system (method and apparatus) for use with a primary waste water treatment system. More particularly, the present invention relates to improvements in floatables removal which allow removal of these items from the upstream side of the bar rack screening apparatus of the waste water treatment system.

### BACKGROUND

Waste water treatment systems used in the industry generally include, but are not limited to, the following treatment processes: grit removal, fine screening, flow equalization and primary clarification. The typical treatment processes are dependent on the velocity at which the waste water is moving through the system. Waste water, however, is not produced continually by humans, but instead is created in batch type processes, such as showering, flushing a toilet, or operating a washing machine. Such water consumptive activities are generally repetitive, resulting in daily, weekly, monthly and yearly diurnal flow patterns for a specific waste water treatment system. Accordingly, the volume of waste water produced, and the velocity of that waste water through the treatment system, vary significantly throughout the day.

In the prior art, grit removal is generally performed in a grit chamber which is velocity sensitive. The most common method to remove grit is by reducing the velocity of the influent flow so that the grit settles out, utilizing a rectangular or circular channel/tank. Either tank causes the grit to settle in a sump, separating the organics from the grit so that the organics can move forward to the biological processes. The grit is then pumped out of the sump to a grit washer and then discharged to a dumpster for disposal at a landfill.

Fine screening is typically accomplished by placing a screen in an influent channel. The influent channel must have a minimum velocity of 1.25 feet per second to keep solids from settling out in the channel and a maximum velocity of 3.0 feet per second to keep solids from being forced through the screen. Such a flow is difficult to achieve due to the large variation in diurnal and pumped flow patterns.

Typical primary clarifiers are also velocity sensitive with the heavy solids going to the base of the clarifier where they are pumped to a digester, the floatable solids, grease and scum are trapped and skimmed off the surface and the neutral buoyant solids/clarified waste water exits the basin via an influent weir. Primary clarifiers are typically large tanks designed for gravity settling and may include electrical drives, flights and chains, rack arms and paddles, or suction tubes and sludge pumps.

Flow equalization typically occurs in a separate tank. The flow at the waste water plant is subject to travel times in the collection system, collection system design and pump station sizing. In general, larger collection systems use pump stations to lift the waste water to the treatment facility. The pumps are typically placed on variable-frequency drives in an attempt to provide a consistent uniform flow. The system of variable-frequency drives and pumps, however, fails in low and high flow conditions. The pumps must be designed for peak hourly flows and have minimum turn down capabilities.

Traditionally, waste water treatment plants have static bar racks or mechanically cleaned bar screens in channels at the entrance of the waste water into the treatment facility. These influent channels are typically constructed of concrete so as to last the life of the facility and are designed for specific waste water volumes, velocities (1 to 3 feet per second), and the insertion of specific screening and grit removal equipment.

The social behavior of flushing solids that should go to landfill (such as baby wipes, diapers, swizzle sticks, condoms, tampon applicators, etc.) creates issues for the operation of the waste water treatment facility. Many of these solids are neutrally buoyant or will float in the waste water. Elongated solids align with the flow and pass or are forced through the bar racks or mechanical screens because of the high flow. Flat sheet solids such as diapers and baby wipes can cover the bar racks or screens, causing the liquid level in the channel to rise and enter a bypass channel. These solids often end up creating issues in the treatment plant such as fouling of pumps, valves, diffusers, and membranes, and ultimately ending up in the digester or sludge holding tank.

The increase in frequency and intensity of storm events producing exceptional precipitation, combined with leaky sewage collection systems, produces greater volumes of waste water delivered to the waste water treatment plant. The cost to repair or replace the aged collection systems of developed nations is not fiscally feasible or achievable in the time frame needed. Therefore, the limited cross-sectional area of an existing channel requires an innovative approach to solve the above issues. The solution must be efficient in consideration of the goal to convert energy consumptive waste water treatment plants to sustainable resource recovery facilities where possible.

To accomplish the above, the influent channels must be replaced with tanks, as disclosed in U.S. patent application Ser. No. 14/142,099 (“the parent application”). Waste water design engineers and manufacturers of screening equipment recognize that high velocities and screening are in conflict. Yet the use of channels at the head of the waste water treatment process is still taught to engineering students today.

An additional problem is the removal of solids from the bar racks or screens. As used herein, the interchangeable terms “bar rack” and “bar screen” should be taken to mean any primary screening device in the influent flow path ahead of a settling tank.

### BRIEF SUMMARY

Recently, a single tank waste water treatment system was developed which eliminates many problems associated with the prior art designs. The system comprises a single primary settling tank that performs grit removal, flow equalization, primary clarification and fine screening. This waste water treatment system is described in U.S. Pat. No. 7,972,505 (the '505 patent), the disclosure of which is incorporated by reference in its entirety for al purposes herein.

The parent application discloses an improvement suitable for use with industrial and municipal waste water treatment. It is also useful for clarifiers, settling tanks, or biological processes such as sequencing batch reactors that have changes in liquid elevations in these tanks and for industrial process waste waters containing high or low specific gravity constituents.

In conventional systems, bar racks are cleaned by mechanically scraping and spraying with a wash which may be water or a combination of water and a cleaning agent such as citric acid. In one aspect of the current application, the waste water treatment system includes a backwash valve on the same side of the bar screen as the water inlet such that when the water inlet is closed and the backwash valve is open, water flows from the primary settling tank through the bar screen and through the backwash valve so that water and debris caught in the bar screen on the full tank are removed from the bar screen.

In another aspect of the present application, backflushing of the bar rack is performed by causing already-screened influent in the settling tank to flow backwards in a timely way through the bar rack to a drain, thereby removing floatables and large solids trapped against the upstream side of the bar rack.

### BRIEF DESCRIPTION OF THE SEVERAL VIEWS OF THE DRAWINGS

The foregoing and other objects, features, and advantages of the invention will be apparent from the following drawings and more particular description of the preferred embodiments of the invention, wherein:

FIG. 1 is a partial-cutway perspective view of a single tank waste water treatment installation, substantially identical to that disclosed in FIG. 2 of the parent application;

FIG. 2 is a schematic elevational view of a first embodiment of a portion of a wastewater treatment system in accordance with the present application;

FIG. 3 is a schematic elevational view of a second embodiment of a portion of a wastewater treatment system in accordance with the present application;

FIG. 4a is a schematic elevational view of a third embodiment of a portion of a wastewater treatment system in accordance with the present application;

FIG. 4b is a schematic plan view of a portion of a wastewater treatment system shown in FIG. 4a;

FIG. 5a is a schematic plan view of a portion of a wastewater treatment system in accordance with the present application, showing a first drainage arrangement;

FIG. 5b is a schematic plan view of a portion of a wastewater treatment system in accordance with the present application, showing a second drainage arrangement;

FIG. 5c is a schematic plan view of a portion of a wastewater treatment system in accordance with the present application, showing a third drainage arrangement; and

FIG. 6 is a schematic elevational view of a fourth embodiment of a portion of a wastewater treatment system in accordance with the present application.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the disclosure. Accordingly, the specification and drawings are to be regarded as illustrative rather than restrictive. It is to be further noted that the drawings are not to scale.

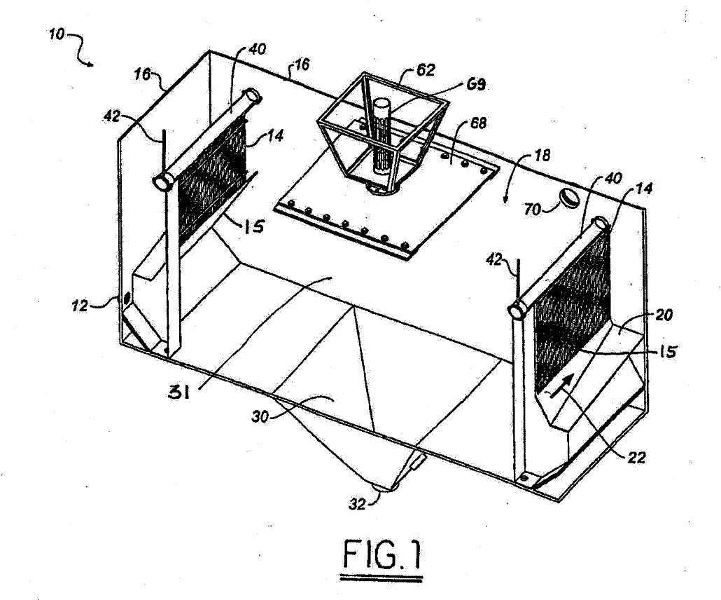

FIGS. 1 through 6 illustrate the invention. The present invention is a system (method and apparatus) for backflushing materials from the upstream side of a bar screen in a primary waste water treatment system.

FIG. 1 shows a rectangular primary settling tank disclosed in the parent application. Primary settling tank 10 receives waste water from a waste water collection system through an influent pipe 12 controlled by a control valve (not shown). The waste water treatment system may also be used in other applications that benefit from an equalized flow into the waste water treatment processes, such as industrial batch discharges, storm water, and septic receiving at a waste water treatment plant. Waste water reaches the waste water treatment system as a result of gravity, the operation of pumps, or both. The primary setting tank has outer walls 16. A bar rack 14 is placed in the primary settling tank 10 between the outer wall 16 and the interior 18 of the primary settling tank 10. Bar rack 14 keeps large solids and floatables from entering the waste water treatment system.

Primary settling tank 10 is sized based on the daily flow patterns for the collection system using generally known engineering practices. The size of the primary settling tank 10 is large compared to the diameter of influent pipe 12 such that the velocity of the incoming flow decreases dramatically upon entrance of the water into primary settling tank 10. Preferably, the incoming velocity is further reduced by splitting the flow so there are two influent pipes 12 at opposite ends of tank 10 (second influent pipe 12 is not visible in cutaway FIG. 1). An influent feed trough 20 receives the incoming waste water and directs the flow in the direction of arrow 22. As the water level rises to the level of the bar screen 14, scum and sludge (not shown) pass through the bar screen 14, over a fixed weir 15, and into the interior 31 of tank 10. Large floatables (not shown), such as plastic solids, are prevented from passing through the bar screen 14. Sludge collects by gravity in the sludge hopper 30, and can be removed from the sludge hopper 30 through outlet 32. A scum and floatables trough 40 is provided to collect scum and floatables that passes through bar screen 14. A handle 42 is connected to the scum and floatables trough 40 to control the angular position of the scum and floatables trough 40. A scum and floatables collection box (not shown) is in fluid communication with the scum and floatables trough 40.

Primary settling tank 10 is shown with a screen box 62 and baffle plate 68. The position of the screen box determines the level of water in the primary settling tank 10. An overflow outlet 70 prevents water from flowing over the sides of the primary setting tank 10 if the water level rises too high.

A As disclosed fully in the parent application, the primary settling tank may be circular, and the backflushing system of the present invention may be readily adapted thereto by one of ordinary skill in the art.

In operation, the prior art primary treatment system performs primary separation of large floatables, grease, and scum from smaller floatables, grease and scum via bar screen 14. The smaller floatables, grease, and scum that pass through bar screen 14 are separated from the liquid influent in two ways: a) by overflowing into trough 40 and b) via screen box 62 and baffle plate 68. Screen box 62 provides a second and fine screening, allowing finely-screen liquid influent to pass through a central drain 69 and attached hose to an additional drain for secondary treatment in known fashion (hose and drain not shown). Flow into tank 10 preferably is intermittent, allowing gravitational separation of grit and heavy particles into grit hopper 30 and fostering a relatively clear supernatant layer at the top of the liquid. Further, because inflow velocities over weir 15 are low and the tank is replenished from relatively near the bottom, the mass of liquid in the tank experiences a general upwelling with small horizontal flow components near screen box 62.

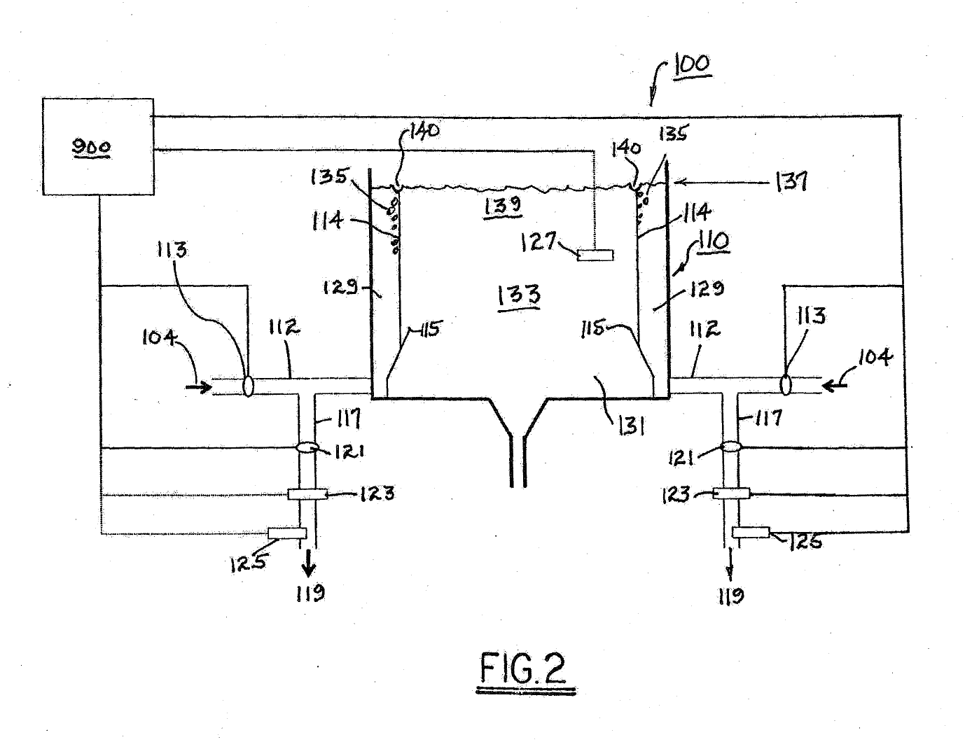

Referring now to FIGS. 1 and 2, in a first embodiment 100 of a system in accordance with the present application for backflushing a bar screen, an exemplary primary settling tank 110 is substantially the same as tank 10 in FIG. 1, and comprises first and second bar screens 114 topped by respective first and second scum and floatables troughs 140. (As used herein, the terms “backflush” and “backwash” are interchangeable.) Influent flows 104 through first and second influent feed pipes 112 are controlled by first and second control valves 113 and programmable controller 900, optionally a dedicated computer. Each of influent feed pipes 112 is provided with a sidearm drain pipe 117 extending to a drain 119, and includes a drain valve 121 and optionally a flow meter 123 and optional sensor 125 connected to programmable controller 900. Further, an optional sensor 127 connected to programmable controller 900 may be positioned within tank 110 for immersion in a reservoir of screened influent 133.

System 100 may be operated manually without the assistance of programmable controller 900, but the preferred embodiment includes programmable controller 900 to allow various modes of automation.

In operation, influent 104 flows through valves 113 and feed pipes 112 into first and second chambers 129 upstream of bar screens 114. A first portion of influent 104 passes through bar screens 114, over weirs 115, and into the interior 131 of tank 110, defining primary screened influent 133. A second portion 135, typically comprising grease, scum, solids, fibrous materials, and floatables, is retained against the upstream side of bar screens 114. At equilibrium upward flow, the level 137 of screened influent 133 reaches scum and floatables troughs 140 where grease, scum, and floatables are removed as described in the parent application.

Over time, significant quantities of second portion 135 accumulate and must be removed from the upstream sides of bar screens 114.

When tank 110 is near full, screened influent 133 has been in tank 110 long enough that suspended materials have settled from screened influent 133, as described above, leaving a relatively clear supernatant liquid 139 near the top of tank 110.

In a first step, programmable controller 900 closes inlet valves 113 and opens drain valves 121, allowing influent in chambers 129 to flow under gravity to drains 119. The concomitant drop in hydrostatic pressure against the upstream sides of bar racks 114 causes liquid 139 to flow outward through bar racks 114 into chambers 129 and then to drains 119. A sufficiently vigorous backflow flushes accumulated grease, scum, solids, fibrous materials, and floatables 135 from the bar racks and down drains 119. When bar racks 114 have been suitably cleaned, drain valves 121 are closed and inlet valves 113 are re-opened.

In one embodiment, scum and floatables may be removed from influent 133 and 139 manually or via troughs 140 prior to starting a bar rack cleaning cycle.

In another embodiment, the bar rack cleaning, cycle is performed after a predetermined number of cycles of filling and emptying the tank in standard influent treatment cycles.

In another embodiment, inlet valves 113 are closed and drain valves 121 opened in response to a signal from sensor 127 to programmable controller 900, which signal may indicate that the upper portion 139 of screened influent 133 has a BOD level above an acceptable threshold as measured by a UV absorption sensor in known fashion.

In another embodiment, the bar rack cleaning cycle is performed after sensor 127 indicates that upper portion 139 has a turbidity level below an acceptable threshold. In such instance, sensor 127 typically comprises a turbidimeter or particle counter.

Closing of drain valves 121 may be performed after a predetermined amount of fluid has been backwashed through the bar racks as observed and manually activated by an operator.

In one embodiment, the amount of fluid backwashed through the bar racks is measured via flow meters 123.

In another embodiment, the amount of fluid backwashed through the bar racks is governed by mode signals of UV absorption, turbidity, or particles from sensors 125 to programmable controller 900.

In another embodiment, cessation of backflushing may be governed by measured increase in BOD or turbidity in tank 110 by sensor 127.

The screened influent 139 that is passed through drains 119, along with all the backflushed materials formerly retained by bar racks 114, must be treated, typically in one or a combination of ways (not shown). In one embodiment, the solids and fluid in the backwash are separated using a dewatering press or a hydrocyclone. The solids are sent to a landfill or otherwise disposed of. The fluid may be returned to the primary settling tank 10 for treatment, or further treated via secondary treatment processes such as a dewatering press or an anaerobic digester.

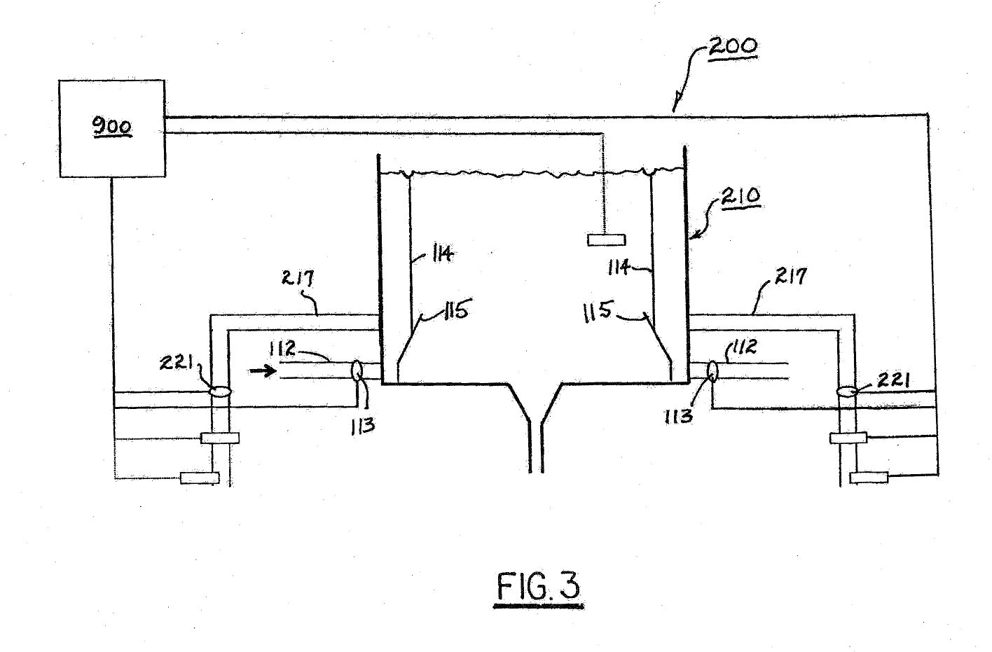

Referring now to FIG. 3, in a second embodiment 200 of a system in accordance with the present invention for backflushing a bar screen, an exemplary primary settling tank 210 is substantially the same as tank 110 in FIG. 2 except as noted below.

The influent fill pipe and ports 112, and valves 113, are positioned essentially as shown in FIG. 2 at or near the bottom of tank 210. However, separate drain pipe and ports 217 and valves 221 are provided, preferably at about the elevation at which bar racks 114 come into contact with the walls of weirs 115. This is the region associated with highest fluid velocities passing through the bar rack during filling and during backwash. The higher velocities make this region of the bar racks more prone to trapping larger materials against the bars.

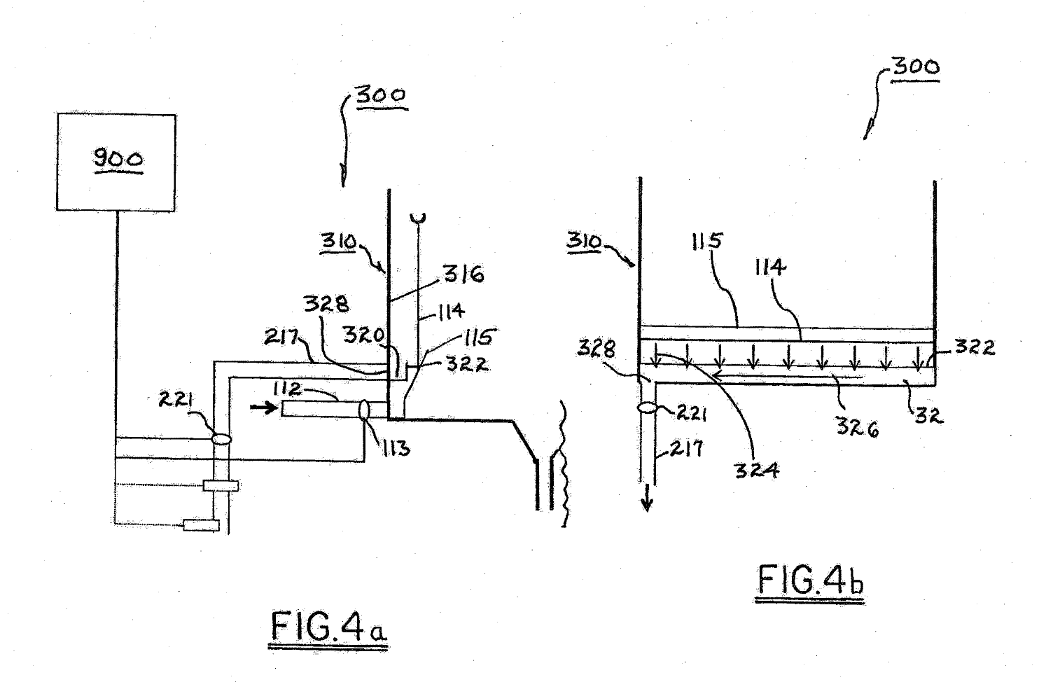

Referring now to FIGS. 4a (elevational view) and 4b (plan view), in a currently preferred third embodiment 300 of a system in accordance with the present invention for backflushing a bar screen, an exemplary primary settling tank 310 is substantially the same as tank 210 in FIG. 3 except as noted below.

An internal sluice 320 is mounted to inner wall 316 of tank 310 and includes an inner sluice lip 322 that defines a weir for the backflush flow 324 from bar rack 114. Internal sluice lip 322 modulates any variations in the amount of backflush flow 324 over the width of bar rack 114, creating a single flow 326 to a single outlet port 328, permitting the outlet port to be located asymmetrically at the end of the sluice as shown.

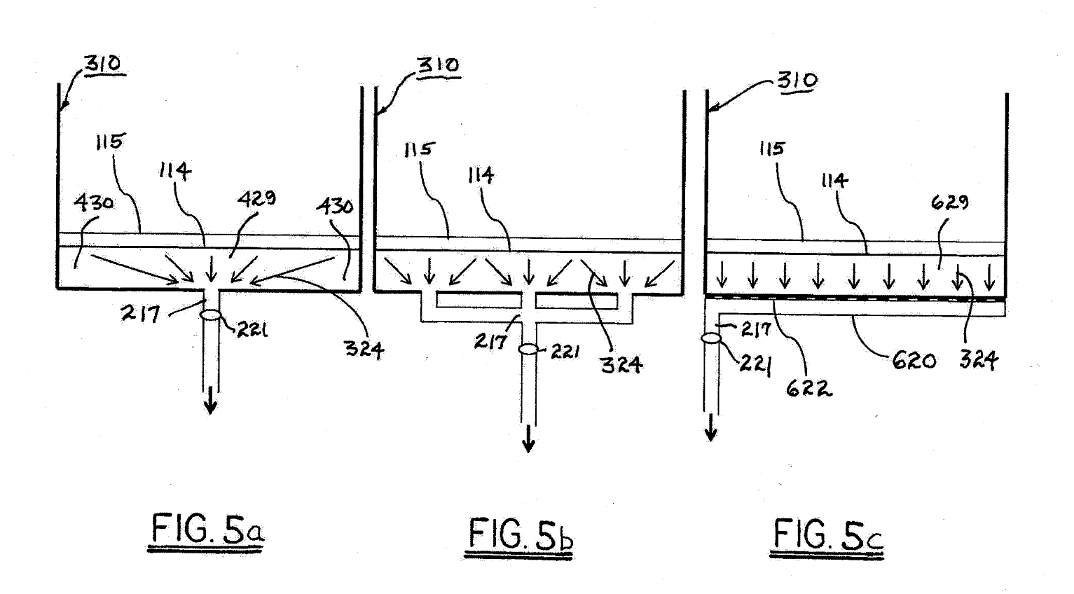

Referring to FIG. 5a, without a sluice, flows 324 being directed to a single outlet port 428 may not flow uniformly from all parts of bar rack 114 and may tend to stagnate in the ends 430 of chamber 429.

Referring to FIG. 5b, such stagnation may be prevented to some degree by providing a manifold of a plurality of outlet ports 528.

Referring to FIG. 5c, the ultimate manifold is simply an external sluice 620 disposed on the outer wall of tank 310 and connected through the tank wall with chamber 629 via a sluice gate 622.

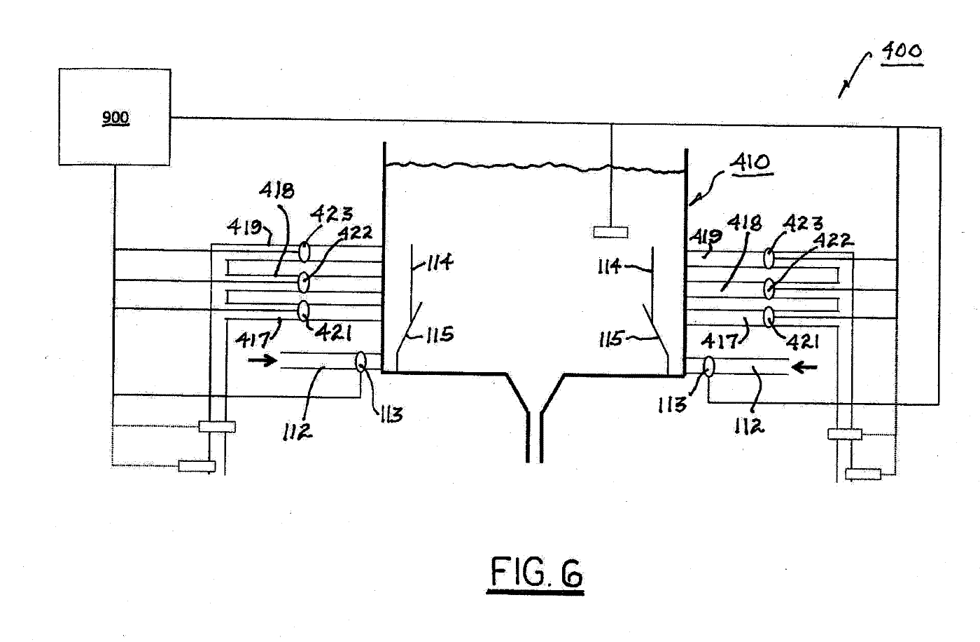

Referring now to FIG. 6, in a fourth embodiment 400 of a system in accordance with the present invention for backflushing a bar screen, an exemplary primary settling tank 410 is substantially the same as tank 210 in FIG. 3 except as noted below.

The influent fill pipe and ports 112, and valves 113, are positioned essentially as shown in FIG. 4 at or near the bottom of tank 410. However, separate drain pipes and ports 417, 418, 419 and valves 421, 422, 423 are provided. The elevation of the drain pipes and ports 417, 418, 419 are arranged to provide control of fluid velocities at the corresponding elevation of the bar rack during the backwash process. Selectively partial or complete opening of valves 417, 418, 419 provides the ability to selectively control the relative fluid velocities at each corresponding elevation during the backwash process.

As will be apparent to those skilled in the art in light of the foregoing disclosure, many alterations and modifications are possible in the practice of this invention without departing from the spirit or scope thereof.

What is claimed is:

1. A system for backflushing materials from the upstream side of a bar screen in a primary waste water treatment installation having a reservoir of influent material disposed within a primary settling tank on the downstream side of the bar screen, comprising:
a) a drain pipe on the upstream side of said bar screen in communication with the interior of said primary settling tank;
b) a drain valve disposed in said drain pipe; and
c) a programmable controller controllably connected to said drain valve.

2. A system in accordance with claim 1 further comprising a first sensor disposed in said drain pipe in communication with said programmable controller.

3. A system in accordance with claim 2 wherein the mode of operation of said first sensor is selected from the group consisting of ultraviolet absorption, turbidity, and particle counter.

4. A system in accordance with claim 1 further comprising a second sensor disposed in said reservoir in communication with said programmable controller.

5. A system in accordance with claim 4 wherein the mode of operation of said second sensor is selected from the group consisting of ultraviolet absorption, turbidity, and particle counter.

6. A system in accordance with claim 1 further comprising a flowmeter disposed in said drain pipe and in communication with said programmable controller.

7. A system in accordance with claim 1 wherein said drain pipe is connected to a drain port formed in a wall of said primary settling tank and separate from said entry port.

8. A system in accordance with claim 1 further comprising an internal sluice disposed against an inner wall of said primary settling tank.

9. A system in accordance with claim 1 further comprising an external sluice disposed against an outer wall of said primary settling tank.

10. A method for backflushing materials from the upstream side of a bar screen in a primary waste water treatment installation having a reservoir of influent material disposed within a primary settling tank on the downstream side of the bar screen, comprising the steps of:
a) providing a drain pipe in communication with the interior of said primary settling tank, a drain valve disposed in said drain pipe, and a programmable controller controllably connected to said drain valve and to an influent supply valve disposed in an influent supply pipe connected to an entry port in said primary settling tank;
b) closing said influent supply valve;
c) opening said drain valve;
d) allowing said influent material disposed within said primary settling tank on the downstream side of said bar screen to flow to a drain from said reservoir through said bar screen, said drain pipe, and said drain valve; and
e) closing said drain valve.

11. A method in accordance with claim 10 wherein said opening and closing steps are controlled manually.

12. A method in accordance with claim 10 wherein said opening and closing steps are controlled by said programmable controller.

13. A method in accordance with claim 12 comprising the further step of providing a first sensor connected to said programmable controller and disposed in said reservoir, wherein said opening and closing steps are responsive to first signals from said first sensor to said programmable controller.

14. A method in accordance with claim 13 wherein said first signals are selected from the group consisting of ultraviolet absorption, turbidity, and particle count.

15. A method in accordance with claim 12 comprising the further step of providing a second sensor connected to said programmable controller and disposed in said drain pipe, wherein said opening and closing steps are responsive to second signals from said second sensor to said programmable controller.

16. A method in accordance with claim 15 wherein said second signals are selected from the group consisting of ultraviolet absorption, turbidity, and particle count.

17. A method in accordance with claim 12 comprising the further step of providing a flowmeter connected to said programmable controller and disposed in said drain pipe, wherein said opening and closing steps are responsive to signals from said flowmeter to said programmable controller.

18. A system for backflushing materials from the upstream side of a bar screen in a primary waste water treatment installation having a reservoir of influent material disposed within a primary settling tank on the downstream side of the bar screen, comprising:
a) at least two drain pipes on the upstream side of said bar screen in communication with the interior of said primary settling tank, wherein a first drain pipe of said two or more drain pipes is in communication with the interior of said primary settling tank at a first elevation, and wherein a second drain pipe of said two or more drain pipes is in communication with the interior of said primary settling tank at a second elevation;
b) a first drain valve disposed in said first drain pipe and a second drain valve disposed in said second drain pipe; and
c) a programmable controller controllably connected to at least one of said first drain valve and said second drain valve.

19. A system for backflushing materials from the upstream side of a bar screen in a primary waste water treatment installation having a reservoir of influent material disposed within a primary settling tank on the downstream side of the bar screen, comprising:
a) at least two drain pipes on the upstream side of said bar screen in communication with the interior of said primary settling tank, wherein a first drain pipe of said at least two drain pipes is in communication with the interior of said primary settling tank at a first elevation, and wherein a second drain pipe of said at least two drain pipes is in communication with the interior of said primary settling tank at a second elevation;
b) a third drain pipe in communication with said first drain pipe and said second drain pipe;
c) a drain valve disposed in said third drain pipe; and
d) a programmable controller controllably connected to said drain valve.
